(19) United States
(12) Patent Application Publication
(10) Pub. No.: US 2007/0231451 A1
(43) Pub. Date: Oct. 4, 2007

(54) Food product with a condiment filling portion

(75) Inventors: Jack Allan Livingstone, Aylmer (CA); Edward John Verhoeven, Aylmer (CA); Robert Anthony Verhoeven, St. Thomas (CA)

Correspondence Address: GEORGE A. ROLSTON, SUITE 900, 45 SHEPPARD AVENUE EAST, TORONTO, ON, M2N 5W9, CA

(73) Assignee: 2093468 ONTARIO INC.

(21) Appl. No.: 11/397,014

(22) Filed: Apr. 4, 2006

(51) Int. Cl. A23L 1/221

(52) U.S. Cl. 426/650

(57) ABSTRACT

A food product having a tubular body portion and a condiment filling portion, the tubular body portion having a first open outer end and a second open outer end, and the condiment filing portion provided within the tubular body portion between the first open outer end and the second open outer end. The condiment filling portion being substantially exposed at the first open end and the second open end of the tubular body portion.

### FIELD OF THE INVENTION

The invention relates to a food product, and more particularly relates to a food product having a condiment filling portion.

### BACKGROUND OF THE INVENTION

In recent years there has been an increasing demand for new and novel “finger food products” to serve patrons in restaurants. The growing popularity of entertaining and cooking for guests at home has further increased the demand for flavourful food products that can be easily prepared and served. When serving traditional finger food products presently available in the marketplace, such as frozen french fries, chicken wings and spring rolls, for example, the food preparer must often provide a wide variety of condiments and other sauces for use by the guests to enhance the flavour of the food products. To satisfy the varying tastes and desires of their guests, most food preparers store at least a dozen different condiments and other sauces in their kitchen. If the food preparer entertains guests on an infrequent basis, many of the stored condiments and sauces may become stale.

Efforts have been made to enhance the flavour characteristics of food products, such as french fries, by injecting condiments and sauces through the exterior surface of food products using a syringe or similar method. However, these methods are time consuming and result in only a limited amount of condiment or sauce being injected into the food product. Consequently, the resulting improvement to the flavour and taste of these finger food products is minimal. While injecting the condiment into the food products, the food products often become too cold and/or mangled for the food preparer to serve to their guests.

Accordingly, there is a need for a food product consisting of a tubular body portion and a condiment filling portion which may be easily prepared and served by a food preparer. There is a further need for a food product that has a tubular body portion which is dimensioned to ensure the uniform cooking of the tubular body portion. There is also a need for a food product that has a tubular body portion which is dimensioned to ensure the uniform heating of the condiment filling portion.

### SUMMARY OF THE INVENTION

The present invention is directed to a food product having a tubular body portion and a condiment filling portion. The tubular body portion having a first open outer end and a second open outer end. The condiment filling portion provided within the tubular body portion between the first open outer end and the second open outer end. The tubular body portion has a generally cylindrical shape. The tubular body portion may be generally oval shape or a generally triangular shape. The condiment filling portion is substantially exposed at the first open end and the second open end of the tubular body portion. The tubular body portion having an inner wall which defines an inner chamber for receiving the condiment filling portion wherein the inner chamber extends along the longitudinal axis of the tubular body portion. The inner chamber is dimensioned to facilitate the thorough cooking of the tubular body portion. The condiment filling portion is provided substantially along the inner chamber, wherein the tubular body portion generally surrounds the condiment filling portion. The tubular body portion having an outer cross-section, the outer cross-section having an outer cross-sectional width X and an outer cross-sectional height Y, wherein the ratio of the outer cross-sectional width X to the outer cross-sectional height Y is about 1.0. The inner chamber having an inner cross-section having an inner cross-sectional width A and a cross-sectional height B, wherein the ratio of the inner cross-section width A to the inner cross-sectional height B is about 1.0.

The tubular body portion of the food product may be formed from a vegetable that has been skinned and cored along the longitudinal axis thereof. The tubular body portion of the food product may be formed from a fruit that has been skinned and cored along the longitudinal axis thereof.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a food product made in accordance with a preferred embodiment of the invention;

FIG. 2 is an elevation view of the first open outer end of the food product of FIG. 1 shown with the filling portion within the tubular body portion;

FIG. 3 is an elevation view of the first open outer end of the food product of FIG. 1 shown without the filling portion;

FIG. 4 is a perspective view of the food product of FIG. 1 showing the filling portion within the tubular body portion;

FIG. 5 is an elevation view of the first open outer end of a food product having a generally triangular shaped tubular body portion and inner chamber made in accordance with an alternative embodiment of the present invention;

FIG. 6 is a perspective view of the food product of FIG. 5;

FIG. 7 is an elevation view of the first open outer end of a food product having a generally oval shaped tubular body portion and inner chamber made in accordance with an alternative embodiment of the present invention; and

FIG. 8 is a perspective view of the food product of FIG. 7.

### DETAILED DESCRIPTION OF THE INVENTION

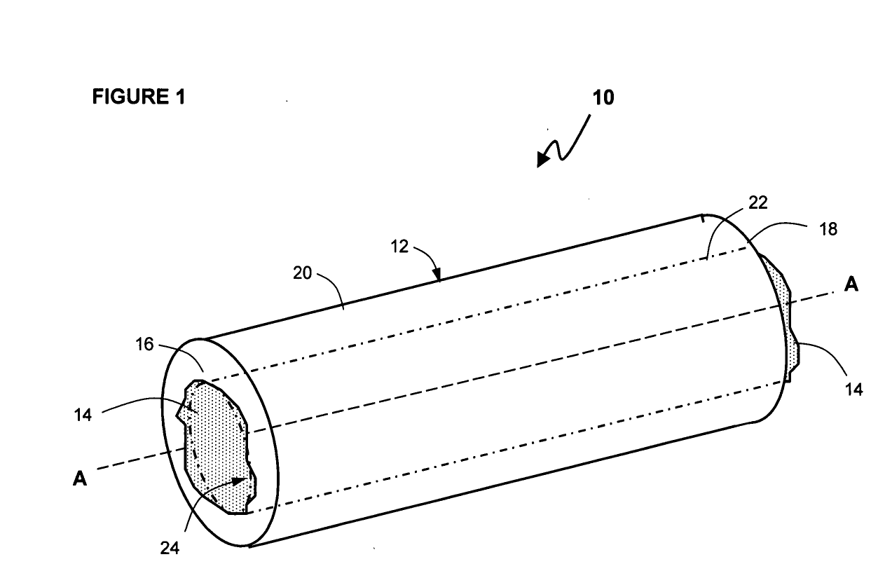

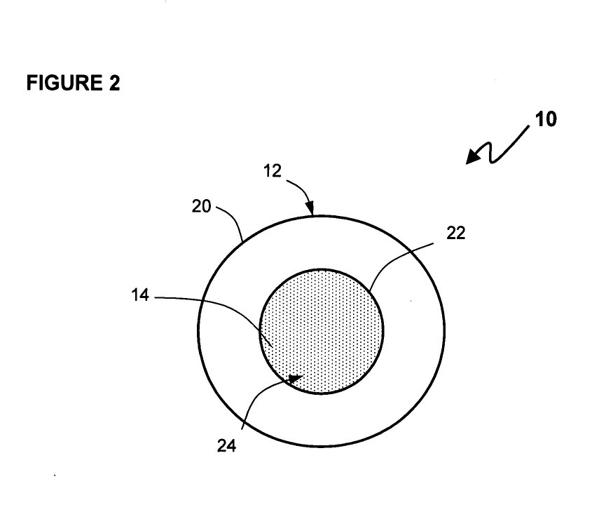

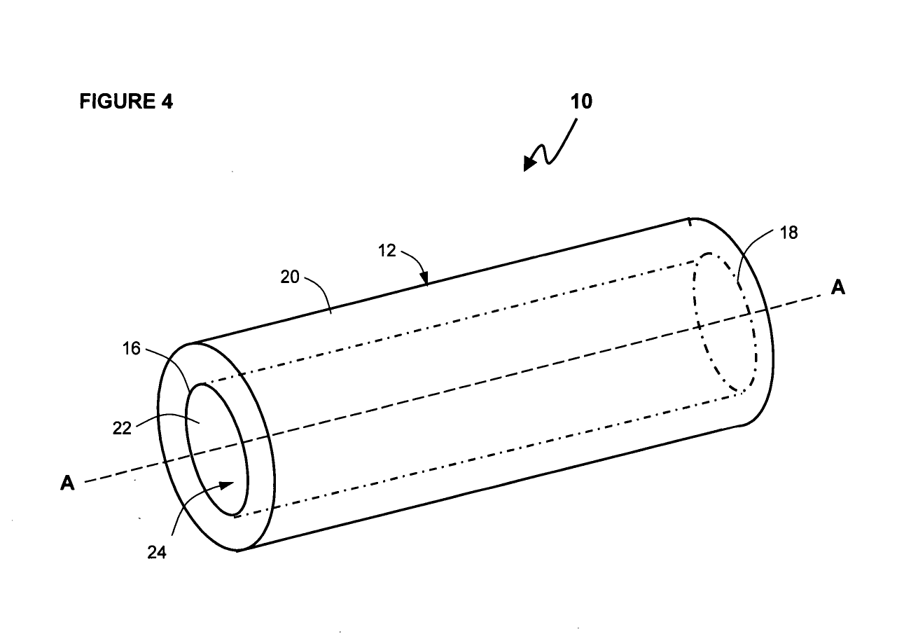

Reference is made to FIGS. 1, 2, 3 and 4 which illustrate a food product 10 made in accordance with a preferred embodiment of the present invention. The food product 10 includes a generally tubular body portion 12 and a condiment filling portion 14 provided and generally received within the tubular body portion 12. The tubular body portion 12 is centered along an axis A-A and extends axially from a first open outer end 16 to a second open outer end 18. The tubular body portion 12 further includes an outer wall 20 and an inner wall 22 centered along the axis A-A which defines a cylindrical inner chamber 24 for receiving the condiment filling portion 14. The inner chamber 24 extends between and terminates at each of the first open outer end 16 and the second open outer end 18.

The tubular body portion 12 may formed of any suitable vegetable or fruit that has been peeled or skinned to form the outer wall 20 of the tubular body portion 12 and cored along the axis A-A to form the inner chamber 24. The inner chamber 24 can be formed using conventional fruit and vegetable coring methods. Preferably, the tubular body portion 12 is formed by removing the outer skin or rind of the vegetable or fruit and then coring the vegetable or fruit to form the inner chamber 24. The condiment filling portion 14 may then be provided within the inner chamber through either or both of the first open outer end 16 and the second open outer end 18. In a preferred embodiment, the tubular body portion 12 is formed from a potato that has been skinned and cored. Any suitable condiment filling portion 14 may then be provided within the inner chamber 24 in accordance with the desired tastes of the consumer of the food product 10.

In alternative embodiments of the present invention, the food product 10 may be formed from any suitable processed vegetables or fruits that have been formed or excluded into the desired shape of the tubular body portion 12. The processed vegetables or fruits may consist of mashed, shredded, powdered, chemically enhanced or other synthetic vegetables or fruits, or any other form of processed vegetables or fruits that are capable of being formed or excluded into the shape of the tubular body portion 12. The tubular body portion 12 formed from the processed vegetables or fruits should be sufficiently rigid to generally maintain the shape of the inner chamber 24 such that the first and second open outer ends do not substantially collapse or close.

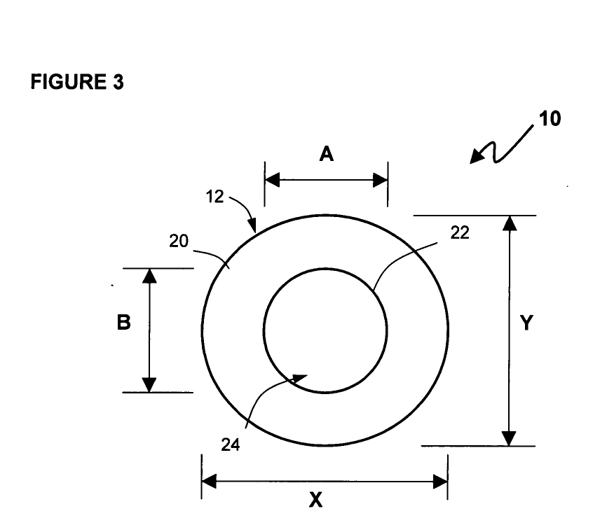

In a preferred embodiment of the present invention, the dimensions of the inner chamber 24 are designed to facilitate the thorough cooking of the tubular body portion 12 and the substantial heating of the filling portion 14. Referring to FIG. 3, the tubular body portion 12 has an outer cross-section having an outer cross-sectional width X to an outer cross-sectional height Y. The ratio of the outer cross-sectional width X to the outer cross-section height Y is less than or equal to 2.0, and more preferably is about 1.0 to ensure uniform cooking of the tubular body portion of the food product 10. Similarly, the inner chamber 24 preferably has an inner cross-section formed by an inner cross-sectional width A to inner cross-sectional height B. The ratio of the inner cross-section width A to the inner cross-sectional height B is less than or equal to 2.0, and more preferably is about 1.0 to ensure the substantial heating of the condiment filling portion 14. By this design, the generally cylindrical configuration of the tubular body portion 12 provides for uniform cooking and heating of the food product 10 as a result of the even distribution of the heat waves or microwaves, for example, around the perimeter of the tubular body portion 12. Moreover, the provision of the condiment filling portion 14 within the tubular body portion 12 before the cooking of the food product 10 provides moisture to the tubular body portion 12 to achieve uniform cooking and heating of the food product 10. The first open outer end 16 and the second open outer end 18 of the food product 10 allow the steam produced by the heating of the filling portion 14 to be released from the food product 10, thereby generally preventing the food product 10 from becoming substantially mangled or deformed during the food preparation process.

The condiment filling portion 14 may be any suitable condiment or food, such as, for example, ketchup, mustard, relish, hot sauce, cheese or other sauces, and may be selected by the consumer based on their taste desires. Various herbs and spices may be added to the condiment filling portion 14 to vary the taste of the food product 10 as well.

In operation, the condiment filling portion 14 of the food product 10 may be provided within the inner chamber 24 after the tubular body portion 12 has been separately cooked by the food preparer. By this method of preparing the food product 10 the food preparer may serve a food product 10 having a warm tubular body portion 12 and a chilled or luke warm condiment filling portion 14, for example. Alternatively, the food preparer may provide the condiment filling portion 14 within the inner chamber 24 before cooking the food product 10. For example, the food preparer may provide a cheese condiment filling portion 14 within the inner chamber 24 using a spoon, such that when the food product 10 is deep-fried or baked, the cheese will melt and at least partially flow from the first and second open outer ends 16 and 18. If the condiment filling portion 14 consists of a liquefied sauce, such as salsa, or the food preparer wishes to prevent the flow of the condiment filling portion 14 from the open outer ends 16 and 18, the food product 10 may be oriented generally vertically or in a standing position on a bake sheet or tray before being cooked. The flow of the condiment filling portion 14 is thereby substantially reduced by obstructing the flow of the filling portion 14 from at least one of the first and second open outer ends 16 and 18. The obstruction further results in a cooked food product 10 having a substantially even distribution of the condiment filling portion 14 along the inner chamber 24 which is desirably uniformly cooked.

It should be understood that the food product 10 may be cooked by the food preparer by any of a variety of different methods, such as, for example, deep frying, oven preparation or microwave preparation. A plurality of the food products 10 may be frozen and provided in a packaging, such as plastic or microwaveable material, for storage and subsequent sale by a grocery store. Following the purchase of the food products 10, the food preparer may remove the desired quantity from the packaging and cook the food products 10 in a deep fryer, oven or microwave, for example.

It should be understood that the tubular body portion 12 and the condiment filling portion 14 of the food product 10 may be separately frozen and provided to the food preparer. By this design, the food preparer may select the desired condiment filling portion 14 to be consumed with the tubular body portion 12. Before cooking or heating the food product 10, the food preparer would provide the frozen condiment filling portion 14 within the inner chamber 24 of the frozen tubular body portion 12. The food product 10 consisting of the frozen tubular body portion 12 and the frozen condiment filling portion 14 may then be cooked or heated by the food prepared by any suitable method. It should be understood that the food products 10 may be at least partially pre-cooked to facilitate the easy preparation of the food products 10 by the food preparer when entertaining guests at home or serving to patrons at a restaurant.

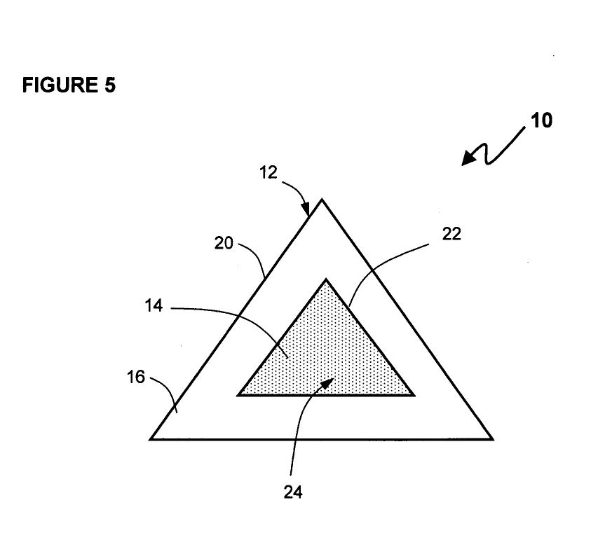

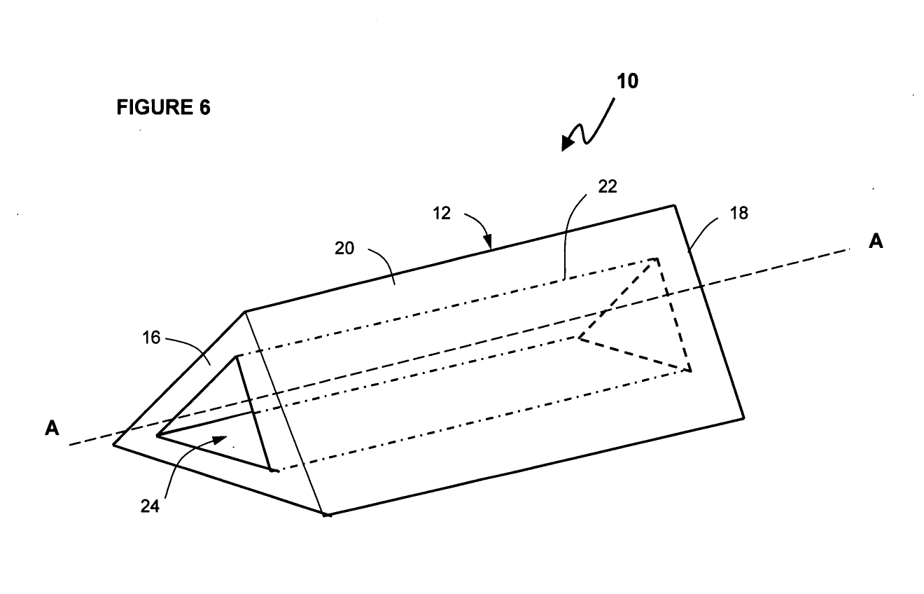

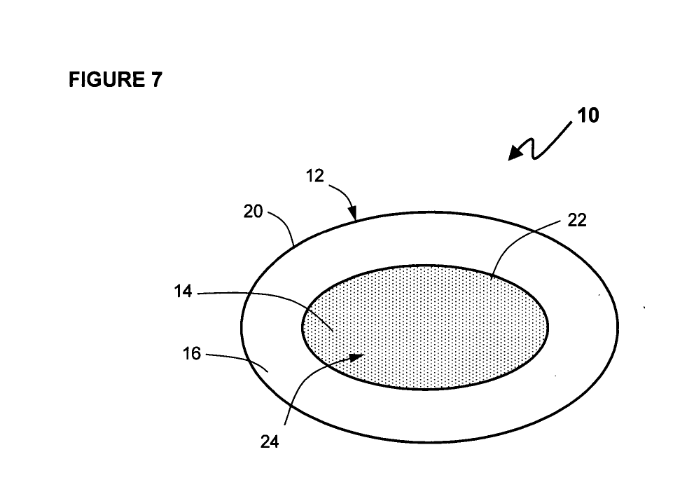

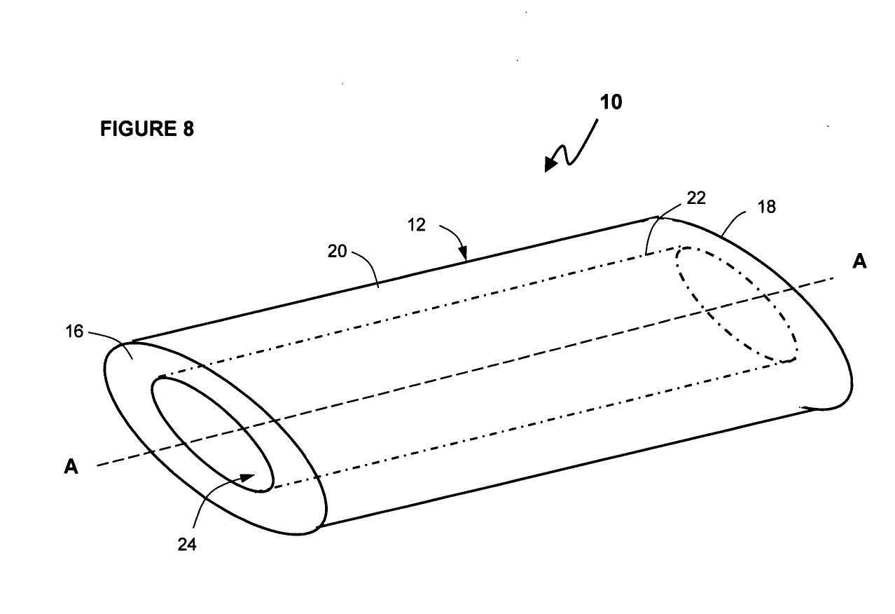

In the preferred embodiment of the present invention shown FIG. 1, 2, 3 and 4, the tubular body portion 12 and the inner chamber 24 are generally cylindrical in shape. It should be understood, however, that the tubular body 12 and the inner chamber 24 may be formed into any suitable shape that facilitates the uniform cooking and heating of the food product 10. For example, the tubular body portion 12 and the inner chamber 24 may be formed into a generally triangular shape as shown in FIGS. 5 and 6. Alternatively, as shown in FIGS. 7 and 8, the tubular body portion 12 and the inner chamber 24 of the food product may be formed into a generally oval shape.

The present invention has been described with regard to specific embodiments. However, it will obvious to persons skilled in the art that a number of variants and modifications can be made without departing from the scope and spirit of the invention, the scope of which is defined in the appended claims.

1. A food product, comprising:
a tubular body portion, the tubular body portion having a first open outer end and an second open outer end; and
a condiment filling portion, the condiment filing portion provided within the tubular body portion between the first open outer end and the second open outer end.

2. The food product as claimed in claim 1, wherein the condiment filling portion is substantially exposed at the first open end and at the second open end of the tubular body portion.

3. The food product as claimed in claim 1, wherein the tubular body portion includes an inner wall which defines an inner chamber for receiving the condiment filling portion.

4. The food product as claimed in claim 1, wherein the inner chamber extends along the longitudinal axis of the tubular body portion.

5. The food product as claimed in claim 1, wherein the tubular body portion having an outer cross-section, the outer cross-section having an outer cross-sectional width X and an outer cross-sectional height Y, and wherein the ratio of the outer cross-sectional width X to the outer cross-sectional height Y is about 1.0.

6. The food product as claimed in claim 3, wherein the inner chamber having an inner cross-section, the inner cross-section having an inner cross-sectional width A and a cross-sectional height B, and wherein the ratio of the inner cross-sectional width A to the inner cross-sectional height B is about 1.0.

7. The food product as claimed in claim 1, wherein the tubular body portion has a generally cylindrical shape.

8. The food product as claimed in claim 1, wherein the tubular body portion has a generally oval shape.

9. The food product as claimed in claim 1, wherein the tubular body portion has a generally triangular shape.

10. The food product as claimed in claim 1, wherein the tubular body portion is formed from a vegetable that has been skinned and cored along the longitudinal axis thereof.

11. The food product as claimed in claim 1, wherein the tubular body portion is formed from a fruit that has been skinned and cored along the longitudinal axis thereof.

12. The food product as claimed in claim 1, wherein the tubular body portion is manufactured from extruded synthetic processed vegetables.

13. The food product as claimed in claim 1, wherein the tubular body portion is manufactured from extruded synthetic processed fruits.

14. The food product as claimed in claim 1, wherein the tubular body portion is formed from a processed vegetable.

15. The food product as claimed in claim 1, wherein the tubular body portion is formed from a processed fruit.

16. The food product as claimed in claim 2, wherein the condiment filling portion is provided substantially along the inner chamber.

17. The food product as claimed in claim 1, wherein the tubular body portion generally surrounds the condiment filling portion.

18. The food product as claimed in claim 3, wherein the inner chamber is dimensioned to facilitate the uniform cooking of the tubular body portion.
